(19) United States
(12) Patent Application Publication
(10) Pub. No.: US 2011/0140987 A1
(43) Pub. Date: Jun. 16, 2011

(54) CHIP ANTENNA

(75) Inventors: Jun Ito, Fukushima (JP); Yuichi Baba, Fukushima (JP)

(73) Assignee: KANTATSU CO., LTD., Yaita-shi, Tochigi (JP)

(21) Appl. No.: 12/737,689

(22) PCT Filed: Aug. 12, 2009
(86) PCT No.: PCT/JP2009/064478

§ 371 Date: Feb. 24, 2011

(30) Foreign Application Priority Data
Aug. 12, 2008 (JP) 2008-207700

(51) Int. Cl. H01Q 21/28

(52) U.S. Cl. 343/893

(57) ABSTRACT

This invention provides a chip antenna which is adaptable to a plurality of frequency bands. It is possible to transmit and receive radio waves in two frequency bands by forming a first antenna element portion 12 and a second antenna element portion 13 having different element lengths on a base body 11 of a chip antenna 10. Radio waves having a high linearity in 3.5 GHz band and 5.8 GHz band can be robustly transmitted and received by forming the first antenna element portion 12 and the second antenna element portion 13 in parallel each other in a longitudinal direction of the base body 11.

### TECHNICAL FIELD

This invention relates to a chip antenna which is suitable for a mobile device, e.g. a mobile phone, PDA (Personal Digital Assistant), a personal computer, a game machine and a home appliance device which accommodates Wireless LAN (local Area Network).

### BACKGROUND ART

Chip antennas are generally known as antennas which are used in mobile phones instead of rod antennas or helical coil antennas. This type of chip antenna has an antenna element portion and a power supply portion which are formed in an appropriated pattern on a surface of a base body. The antenna element portion and a power supply portion are made of e.g. a silver alloy, and the base body is made of dielectric plastic having a high dielectric constant. See Patent Document 1, for example. This chip antenna has an advantage of an ultra-small size and a high performance.

Patent Document 1: Japanese Laid-open Patent Application No. Hei 10-247806

### DISCLOSURE OF INVENTION

### Problems to be Resolved by the Invention

The chip antenna as shown in Patent Document 1 is adaptable only to a single frequency band and cannot transmit and receive radio waves in a plurality of frequency bands. The problem to be resolved by the present invention is to provide a chip antenna which is adaptable to a plurality of frequency bands.

### Means for solving the Problems

A tip antenna according to the present invention is a tip antenna which is adaptable to multiple frequency bands and comprises a plurality of antenna element portions having different element lengths and a base body which is made of dielectric practices, wherein the antenna element portions are formed in parallel each other on the base body.

In a tip antenna according to the present invention, since a plurality of antenna element portions having different element lengths are formed, radio waves in a plurality of frequency bands can be transmitted and received. Additionally, since a plurality of antenna element portions are formed in parallel each other, radio waves having a high linearity in GHz frequency bands can be robustly transmitted and received.

In a tip antenna according to the present invention, it is preferable to form a plurality of power supply portions on the bottom surface of a base body which faces a mounting board so that each of power supply portions is connected to each of the antenna element portions. In this case, it is preferable to form a plurality of power supply portions at positions which are connectable to a single power supply point on the mounting board by changing bonding position of the base body to the mounting board.

In a tip antenna according to the present invention, it is preferable to form antenna element portions and power supply portions by plating a conductive metal material on a base body of dielectric plastic having a dielectric constant in a range between 4 and 20 and patterning a plated layer by an appropriate processing method, e.g. laser processing.

The aforementioned process realizes low cost mass production of chip antenna of small size (or, an ultra-small size), high performance and high dimensional precision which are essential to antennas which are incorporated in small size mobile devices, e.g. next generation mobile phones.

### Effect of the Invention

In a chip antenna according to the present invention, it is possible to transmit and receive radio waves in a plurality of frequency bands by a plurality of antenna element portions having different element lengths. It is also possible to robustly transmit and receive electric waves having a high linearity in GHz frequency bands because the antenna element portions are formed in parallel each other.

According to the present invention, it is possible to easily apply complicated patterning to a small size chip antenna (i.e. forming antenna elements) with a high precision and realize a low cost mass production of high performance small size chip antennas by plating a conductive metal material on a base body which is made of dielectric plastic and patterning a plated layer by an appropriate processing method, e.g. laser processing to form a plurality of antenna element portions having different element lengths and power supply portions which are described above.

Although it is known that a smaller size and higher performance antenna can be formed by using dielectric plastic having a higher dielectric constant ε, the dielectric constant of plastic may change by forming a plated layer or patterning the layer using laser, and such a change in dielectric constant may influence the antenna performance.

Taking such an influence into consideration, according to the present invention, it is preferable to set the dielectric constant ε of the base body (plastic portion) to a vale in a range between 4 and 20 after forming antenna elements.

### BRIEF DESCRIPTION OF DRAWINGS

FIG. 1 shows a perspective view of a chip antenna according to a first embodiment of the present invention showing the top surface and the left side surface of the antenna which is observed from one end in a longitudinal direction.

FIG. 2 shows a perspective view of a chip antenna according to a first embodiment of the present invention showing the top surface and the right side surface of the antenna which is observed from one end in a longitudinal direction.

FIG. 3 shows a perspective view of a chip antenna according to a first embodiment of the present invention showing the bottom surface and the left side surface of the antenna which is observed from the other end in a longitudinal direction.

FIG. 4 shows a perspective view of a chip antenna according to a first embodiment of the present invention showing the bottom surface and the right side surface of the antenna which is observed from the other end in a longitudinal direction.

FIG. 5 shows a plan view of a mounting board to which a chip antenna according to a first embodiment of the present invention is mounted in its left side portion.

FIG. 6 shows a plan view of a mounting board to which a chip antenna according to a first embodiment of the present invention is mounted in its right side portion.

FIG. 7 shows a plan view of a mounting board shown in FIG. 5 and FIG. 6.

FIG. 8 shows a perspective view of a chip antenna according to a second embodiment of the present invention showing the top surface and the right side surface of the antenna which is observed from one end in a longitudinal direction.

FIG. 9 shows a perspective view of a chip antenna according to a second embodiment of the present invention showing the top surface and the right side surface of the antenna which is observed from the other end in a longitudinal direction.

FIG. 10 shows a perspective view of a chip antenna according to a second embodiment of the present invention showing the bottom surface and the right side surface of the antenna which is observed from the one end in a longitudinal direction.

FIG. 11 shows a perspective view of a chip antenna according to a second embodiment of the present invention showing the bottom surface and the right side surface of the antenna which is observed from the other end in a longitudinal direction.

FIG. 12 shows a plan view of a mounting board to which a chip antenna according to a second embodiment of the present invention is mounted in its right side portion.

FIG. 13 shows a plan view of a mounting board to which a chip antenna according to a second embodiment of the present invention is mounted in its left hand portion.

FIG. 14 shows a perspective view of a chip antenna according to a third embodiment of the present invention showing the top surface and the left side surface of the antenna which is observed from one end in a longitudinal direction.

FIG. 15 shows a perspective view of a chip antenna according to a third embodiment of the present invention showing the bottom surface and the left side surface of the antenna which is observed from one end in a longitudinal direction.

FIG. 16 shows a graphic relationship between a transmitting and receiving frequency and a return loss in a chip antenna according to a third embodiment of the present invention shown in FIG. 14.

FIG. 17 shows a perspective view of a chip antenna according to an alternative example which corresponds to a first embodiment of the present invention shown in FIG. 2.

FIG. 18 shows a perspective view of a chip antenna according to an alternative example which corresponds to a first embodiment of the present invention shown in FIG. 1.

### EXPLANATION OF THE REFERENCE NUMBERS

10, 20, 30 chip antenna

11, 21, 31 base body

12, 22 first antenna element portion

13, 23 second antenna element portion

14, 24 first power supply portion

15, 25 second power supply portion

16, 26, 36 land portion

17, 27, 37 ground portion

32 antenna element portion

34 power supply portion

### BEST MODE FOR IMPLEMENTING THE INVENTION

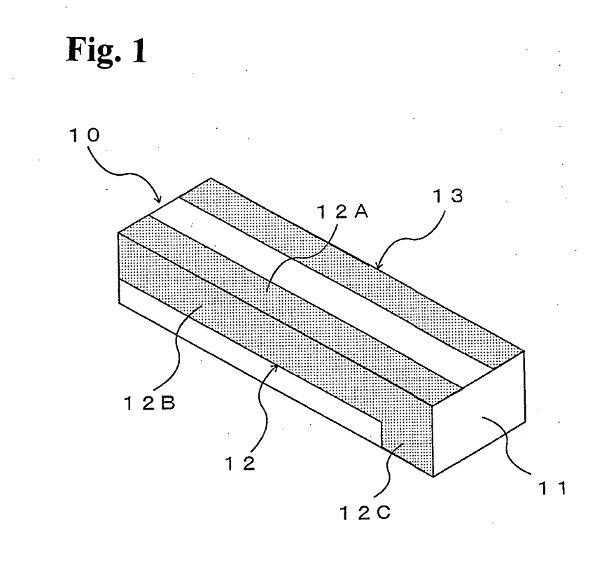

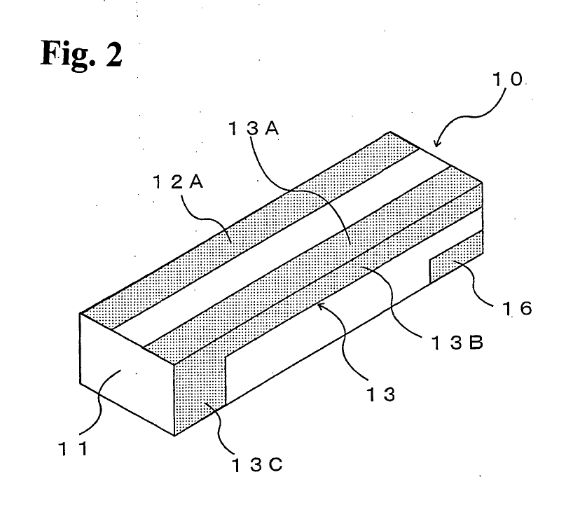

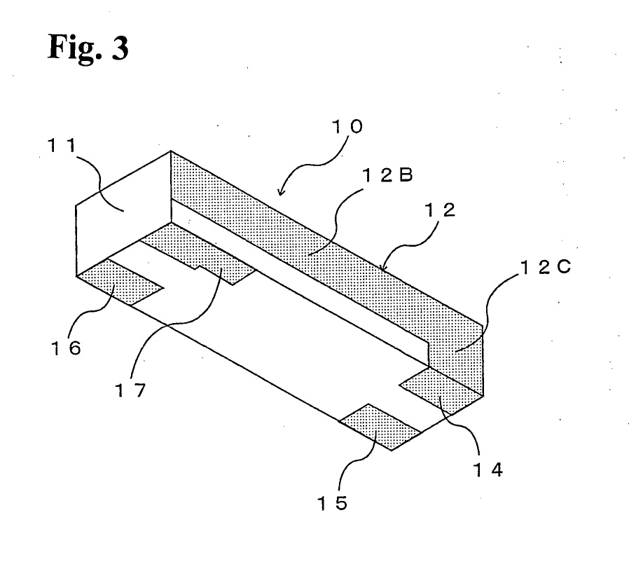

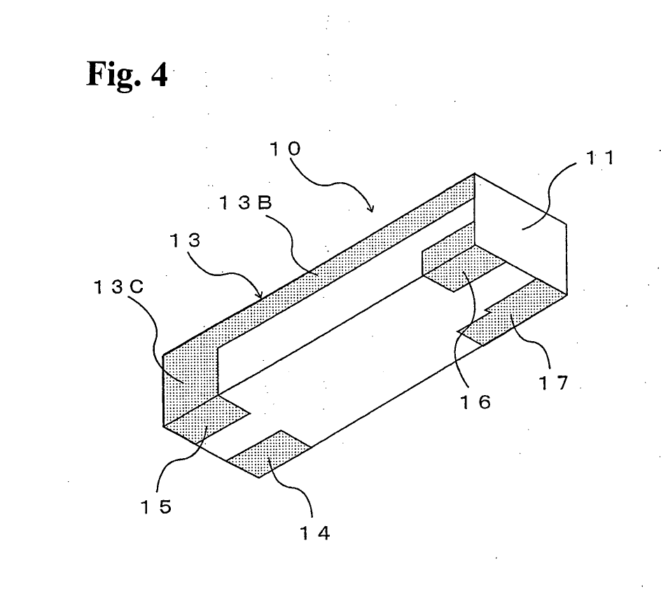

The best mode embodiment of the present invention will be explained below referring to drawings. FIG. 1 shows a perspective view of a chip antenna according to a first embodiment of the present invention showing the top surface and the left side surface of the antenna which is observed from one end in a longitudinal direction. FIG. 2 shows a perspective view of a chip antenna according to a first embodiment of the present invention showing the top surface and the right side surface of the antenna which is observed from one end in a longitudinal direction. FIG. 3 shows a perspective view of a chip antenna according to a first embodiment of the present invention showing the bottom surface and the left side surface of the antenna which is observed from the other end in a longitudinal direction. FIG. 4 shows a perspective view of a chip antenna according to a first embodiment of the present invention showing the bottom surface and the right side surface of the antenna which is observed from the other end in a longitudinal direction.

A chip antenna according to a fist embodiment according of the present invention will be explained referring to FIGS. 1 through 4. A chip antenna 10 according to a fist embodiment of the present invention is a small size and high performance antenna which can be incorporated in a mobile device, e.g. a next generation mobile phone and functions as an antenna which is adaptable to the ¼ wavelength having resonant frequencies in GHz bands.

As shown in FIGS. 1 through 4, the chip antenna 10 according to a fist embodiment of the present invention comprises a base body 11 which is made of dielectric plastic which is formed in a cuboid having a length of 7.5 mm, a width of 2.0 mm and a thickness of 1.5 mm.

A first antenna element portion 12 and a second antenna element portion 13 which are adaptable to two frequencies, a first power supply portion 14 and a second power supply portion 15 for supplying power to the antenna element portions 12 and 13, a land portion 16 for attaching the chip antenna 10 to a mounting board (explained later) and a ground portion 17 which is connected to a ground terminal (GND) on the mounting board.

The dielectric plastic for forming the base body 11 comprises a compound material which compounds ceramics having a high dielectric constant, polyphenylenesulfide resin (PPS) and liquid crystal polymer (LCP), and has a dimensional stability which is suitable for precision molding, a high heat resistance to solder mounting and a high dielectric property with a dielectric constant ε of about 6.

The first antenna element portion 12, the second antenna element portion 13, the first power supply portion 14, the second power supply portion 15, the land portion 16 and the ground portion 17 are formed by plating the based body (made of dielectric plastic) by an appropriate conductive metal material, e.g. copper, nickel, silver alloy and patterning a plated layer in a predetermined shape by laser processing or other appropriate processing methods.

The first antenna element portion 12 is adapted to a frequency in 5.8 GHz band where the ¼ wavelength (λ/4) is shortened to 5.3 mm according to a dielectric constant c of the base body 11 and is formed across the area from the left side potion on the top surface to the left side surface of one end side of the base body 11.

The first antenna element portion 12 is formed in a key shaped pattern by continuously connecting belt shaped linear portions 12A and 12B and a belt shaped bended portion 12C each other. The linear portion 12 A extends from one end to the other end in a longitudinal direction in the left side portion on the top surface of the base body 11. The linear portion 12 B extends from one end to the other end in a longitudinal in the upper portion on the left side surface of the base body 11. The belt shaped bended portion 12C is bended at a right angle and extends from one end of the linear portion 12B to the lower end of the left side surface of the base body 11.

The second antenna element portion 13 is adapted to a frequency in 3.5 GHz band where the ¼ wavelength (λ/4) is shortened to 8.7 mm according to a dielectric constant e of the base body 11 and is formed across the area from the right side potion on the top surface to the right side surface of one end side of the base body 11.

The second antenna element portion 13 is formed in a key shaped pattern by continuously connecting belt shaped linear portions 13A and 13B and a belt shaped bended portion 13C each other. The linear portion 13A extends from one end to the other end in a longitudinal direction in the right side portion on the top surface of the base body 11. The linear portion 13 B extends from one end to the other end in a longitudinal in the upper portion on the right side surface of the base body 11. The belt shaped bended portion 13C is bended at a right angle and extends from one end of the linear portion 13B to the lower end of the right side surface of the base body 11.

The linear portion 13B of the second antenna element portion 13 has about a same width as the linear portion 12A of the first antenna element portion 12 and the two linear portions 12A and 13B are formed in parallel. The bended portion 13C of the second antenna element portion 13 has about a same width as the linear portion 12C of the first antenna element portion 12 and the two bended portions 12C and 13C are formed in parallel.

Although the linear portion 13B of the second antenna element portion 13 is formed in parallel with the linear portion 12B of the first antenna element portion 12, the width of the linear portion 13B of the second antenna element portion 13 is set narrower than the width of the linear portion 12B of the first antenna element portion 12.

Therefore the length of the bended portion 13C of the second antenna element portion 13 is longer than the length of the bended portion 12C of the first antenna element portion 12, and the element length of the second antenna element portion 13 is longer than the element length of the first antenna element portion 12.

Because of the difference in element length, the first antenna element portion 12 can transmit and receive radio waves in 5.8 GHz band, and the second antenna element portion 13 can transmit and receive radio waves in 3.5 GHz band.

The first power supply portion 14 for supplying power to the first antenna element portion 12 is formed in the left side portion on the bottom surface at one end of the base body 11 as shown in FIG. 3 and continues to the bended portion 12B of the first antenna element portion 12.

The second power supply portion 15 for supplying power to the second antenna element portion 13 is formed in the right side portion on the bottom surface at one end of the base body 11 as shown in FIG. 4 and continues to the bended portion 13C of the second antenna element portion 13. The first power supply portion 14 and the second power supply portion 15 are formed at left-right symmetric positions at one end on the bottom surface of the base body.

The land portion 16 for attaching the chip antenna 10 to a mounting board (described later) is formed in the right side portion at the other end on the bottom surface of the base body 11 as shown in FIG. 4. The ground portion 17 which is connected to a ground terminal (GND) is formed in the left side portion on the bottom surface of the base body 11 as shown in FIG. 3.

When the chip antenna 10 according to the first embodiment of the present invention configured as the above is used as an antenna for transmitting and receiving radio waves in 5.8 GHz band, the chip antenna 10 is attached sideways in the left side portion of the mounting board B so that the first power supply portion 14 faces the center portion in the right and left direction of the mounting board B. When the chip antenna 10 is used as an antenna for transmitting and receiving radio waves in 3.5 GHz band, the chip antenna 10 is attached sideways in the right side portion of the mounting board B so that the second power supply portion 15 faces the center portion in a left-right direction of the mounting board B.

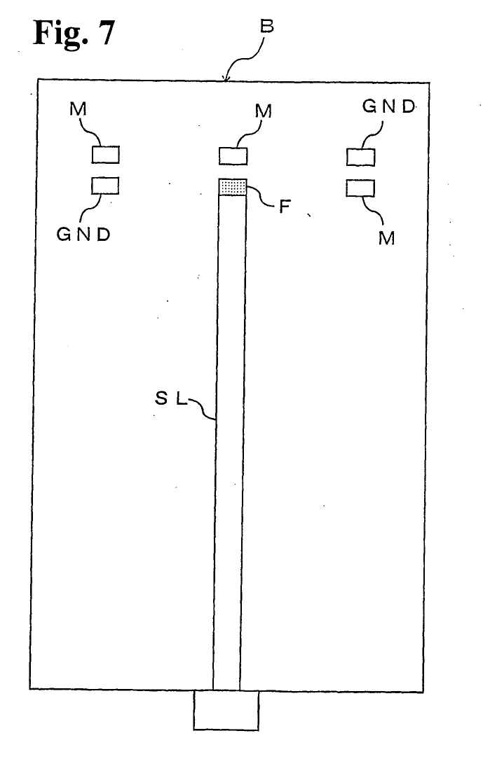

In order to attach the chip antenna 10 to two positions at the left position or the right sides on the mounting board B selectively by rotating the chip antenna 10 by 180°, a single power supply terminal F, a strip line SL and a mount terminal M are positioned in the center portion in a left-right direction of the mounting board B as shown in FIG. 7. The first power supply portion 14 or the second power supply portion 15 is selectively solder-mounted to the power supply terminal F. The strip line SL is connected to the power supply terminal F and extends downward. Either of the first power supply portion 14 or the second power supply portion 15 (which is not bonded to the power supply terminal F of the chip antenna 10) is solder-mounted to the mount terminal M.

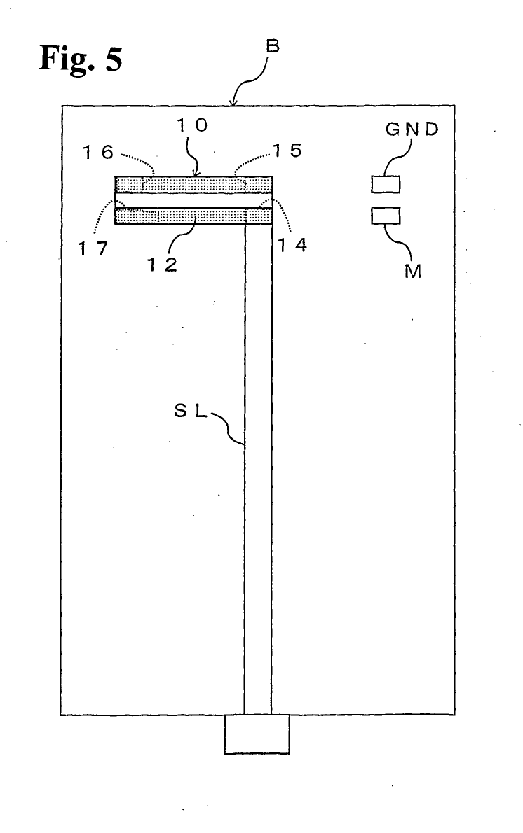

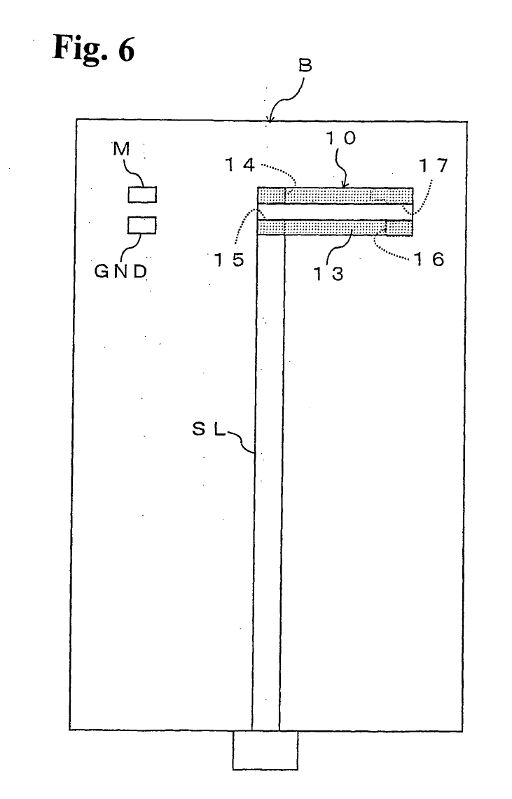

The mount terminal M and the ground terminal GND are positioned in the left side portion on the mounting board B. The land portion 16 and the ground portion 17 of the chip antenna 10 shown in FIG. 5 are respectively solder-mounted on the mount terminal M and the ground terminal GND. The mount terminal M and the ground terminal GND are positioned in the right side portion on the mounting board B. The land portion 16 and the ground portion 17 of the chip antenna 10 shown in FIG. 6 are respectively solder-mounted on the mount terminal M and the ground terminal GND.

The chip antenna 10 attached to the left portion of the mounting board B as shown in FIG. 5 functions as a monopole antenna in which the first antenna element portion 12 can transmit and receive radio waves in 5.8 GHz band by supplying power to the first antenna element portion 12 from the first power supply portion 14 of the chip antenna 10 through the strip line SL and the power supply terminal F on the mounting board B.

The chip antenna 10 attached to the right portion of the mounting board B as shown in FIG. 6 functions as a monopole antenna in which the second antenna element portion 13 can transmit and receive radio waves in 3.5 GHz band by supplying power to the second antenna element portion 13 from the second power supply portion 15 of the chip antenna 10 through the strip line SL and the power supply terminal F on the mounting board B.

The chip antenna 10 according to the fist embodiment of the present invention can robustly transmit and receive radio waves having a high linearity in 3.5 GHz band and 5.8 GHz band.

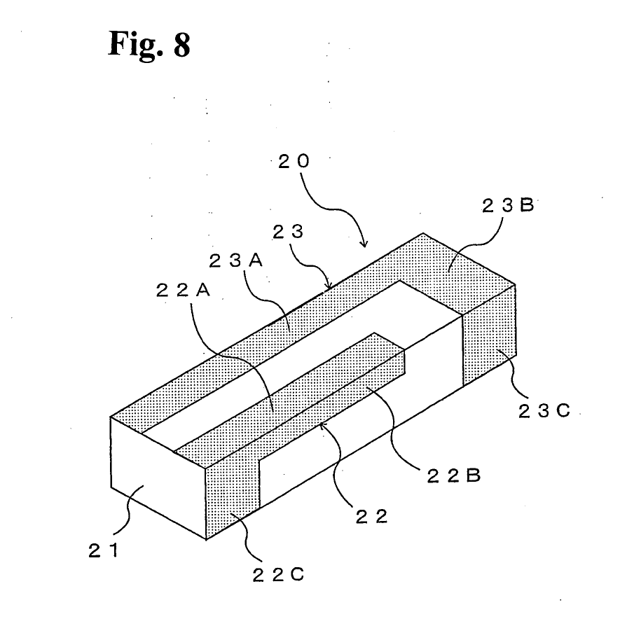

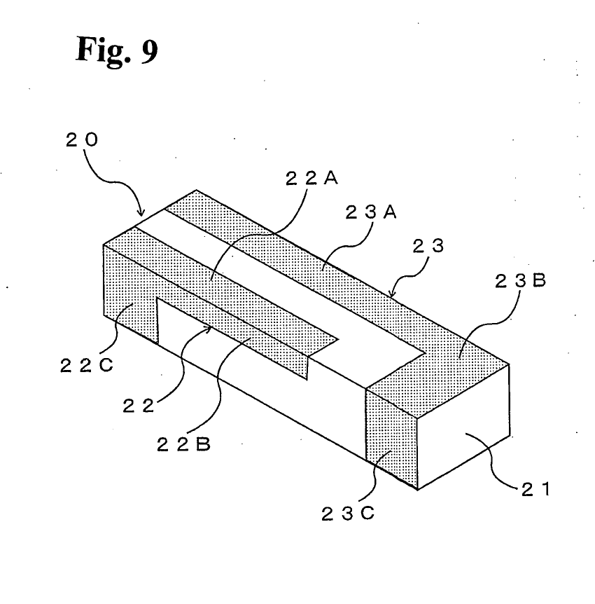

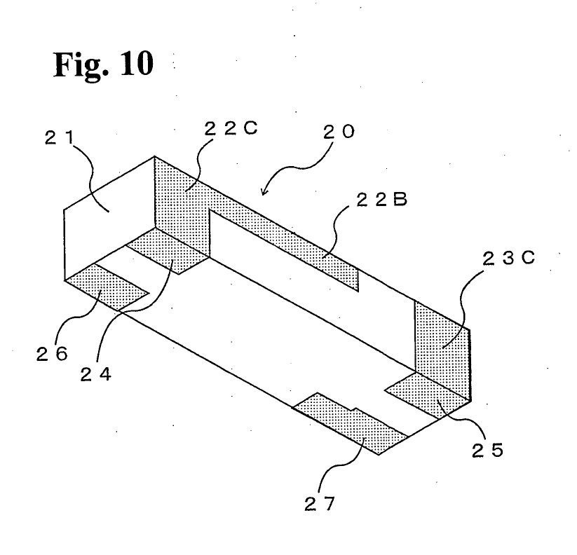

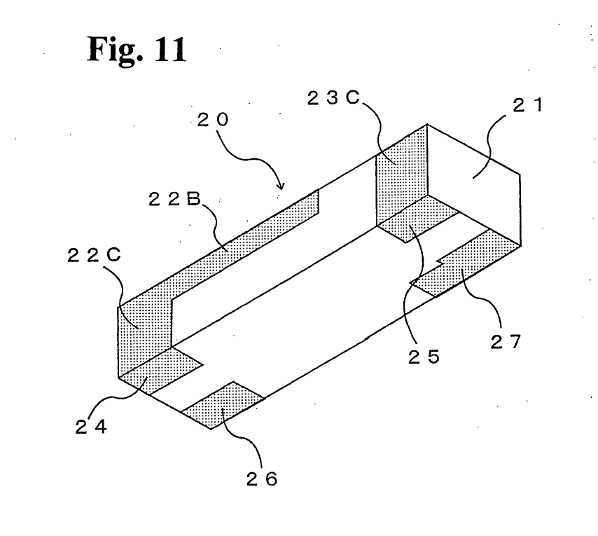

A chip antenna according to a second embodiment according of the present invention will be explained referring to FIGS. 8 through 11. FIG. 8 shows a perspective view of a chip antenna according to a second embodiment of the present invention showing the top surface and the right side surface of the antenna which is observed from one end in a longitudinal direction. FIG. 9 shows a perspective view of a chip antenna according to a second embodiment of the present invention showing the top surface and the left side of the antenna which is observed from the other end in a longitudinal direction. FIG. 10 shows a perspective view of a chip antenna according to a second embodiment of the present invention showing the bottom surface and the right side surface of the antenna which is observed from one end in a longitudinal direction. FIG. 11 shows a perspective view of a chip antenna according to a second embodiment of the present invention showing the bottom surface and the right side surface of the antenna which is observed from the other end in a longitudinal direction.

As shown in FIG. 8 and FIG. 9, the chip antenna 20 according to the second embodiment of the present invention comprises a base body 21 which is similar to the base body 11 in the chip antenna 10 according to the first embodiment of the present invention. A first antenna element portion 22, a second antenna element portion 23, a first power supply portion 24, a second power supply portion 25, a land portion 26 and a ground portion 27 (which respectively correspond to the first antenna element portion 12, the second antenna element portion 13, the first power supply portion 14, the second power supply portion 15, the land portion 16 and the ground portion 17) are formed on the surface of the based body 21.

The first antenna element portion 22 is adapted to a frequency in 5.8 GHz and is formed in a key shaped pattern by continuously connecting belt shaped linear portions 22A and 22B and a belt shaped bended portion 22C each other. The linear portion 22 A extends from one end toward the other end to a predetermined length in a longitudinal direction in the right side portion on the top surface of the base body 21. The linear portion 22 B extends from one end toward the other end to a position where its end line continues to the end line of the linear portion 22A in the upper portion on the right side surface of the base body 11. The belt shaped bended portion 22C is bended at a right angle and extends from one end of the linear portion 22B to the lower side of the right side surface of the base body 11.

The second antenna element portion 23 is adapted to a frequency in 3.5 GHz band and is formed in a key shaped pattern by continuously connecting a belt shaped linear portion 23A and belt shaped bended portions 23B and 23C each other. The linear portion 23 A extends from one end to the other end in a longitudinal direction in the left side portion on the top surface of the base body 21. The bended portion 23 B is bended at a right angle and extends from the other end of the linear portion 23A to the right side on the top surface of the base body 11. The bended portion 23C is bended at a right angle and extends from the bended portion 23B to the lower side of the right side surface of the base body 11.

The element length of the second antenna element portion which includes the linear portion 23A, the bended portions 23B and 23C is longer than the element length of the first antenna element portion 22 which includes the linear portions 22A and 22B and the bended portion 22C. Because of the difference in element length, the first antenna element portion 22 can transmit and receive radio waves in 5.8 GHz band, and the second antenna element portion 23 can transmit and receive radio waves in 3.5 GHz band.

The first power supply portion 24 for supplying power to the first antenna element portion 22 is formed in the right side portion on the bottom surface at one end of the base body 21 and continues to the bended portion 22C of the first antenna element portion 22 as shown in FIG. 10 and FIG. 11.

The second power supply portion 25 for supplying power to the second antenna element portion 23 is formed in the right side portion on the bottom surface at the other end of the base body 21 and continues to the bended portion 23C of the second antenna element portion 23. The land portion 26 is formed in the left side portion of on the bottom surface at one end of the base body 21. The ground portion 27 is formed in the left side portion on the bottom surface at the other end of the base body 21.

When the chip antenna 20 according to the second embodiment of the present invention which is configured as the above is used as an antenna for transmitting and receiving radio waves in 5.8 GHz band, the chip antenna 10 is attached sideways in the right side portion of the mounting board B so that the first power supply portion 24 faces the center portion in a left-right direction of the mounting board B.

When the chip antenna 20 is used as an antenna for transmitting and receiving radio waves in 3.5 GHz band, the chip antenna 20 is attached sideways in the left side portion of the mounting board B so that the second power supply portion 25 faces the center portion in a left-right direction of the mounting board B.

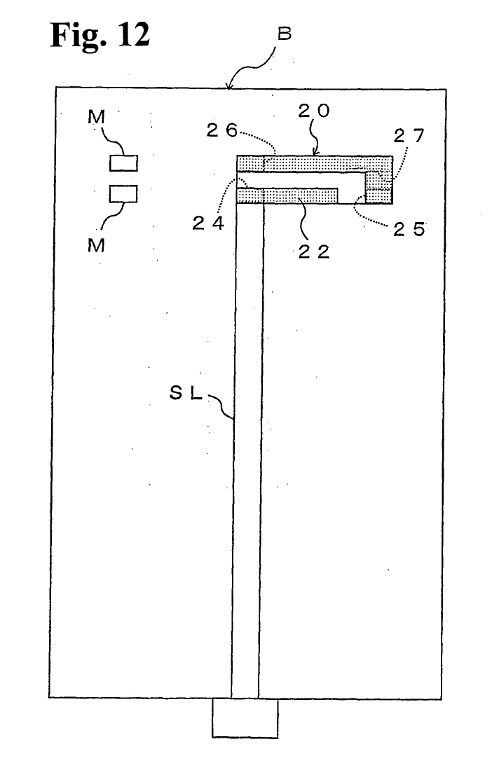

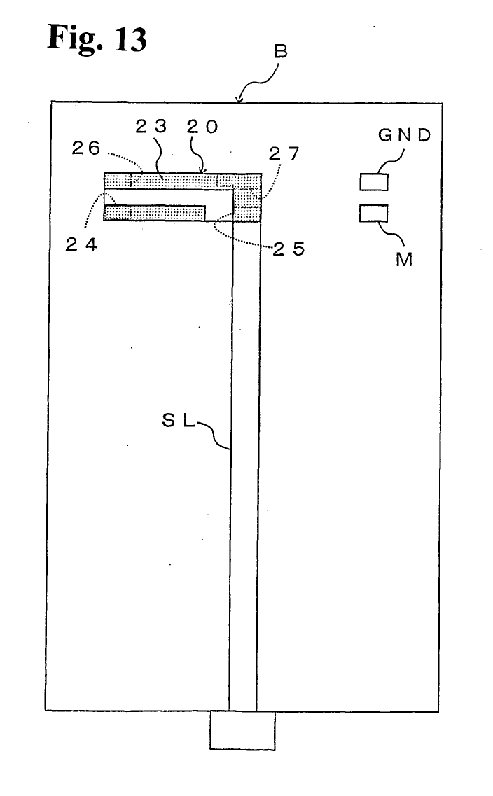

In order to attach the chip antenna 20 to two positions at the left side or the right side on the mounting board B selectively by sliding the chip antenna 10 to a left-right direction, the ground terminal GND in the left side portion on the mounting board B shown in FIG. 7 is changed to a mount terminal M on the mounting board in FIG. 12 and FIG. 13, and the mount terminal M in the center portion on the mounting board B shown in FIG. 7 is changed to a ground terminal GND on the mounting board in FIG. 12 and FIG. 13.

The chip antenna 20 which is attached to the right portion of the mounting board B shown in FIG. 12 functions as a monopole antenna in which the first antenna element portion 22 can transmit and receive radio waves in 5.8 GHz band by supplying power to the first antenna element portion 22 from the first power supply portion 24 of the chip antenna 20 through the strip line SL and the power supply terminal F on the mounting board B.

The chip antenna 20 attached to the right portion of the mounting board B shown in FIG. 13 functions as a monopole antenna in which the second antenna element portion 23 can transmit and receive radio waves in 3.5 GHz band by supplying power to the second antenna element portion 23 from the second power supply portion 25 of the chip antenna 20 through the strip line SL and the power supply terminal F on the mounting board B.

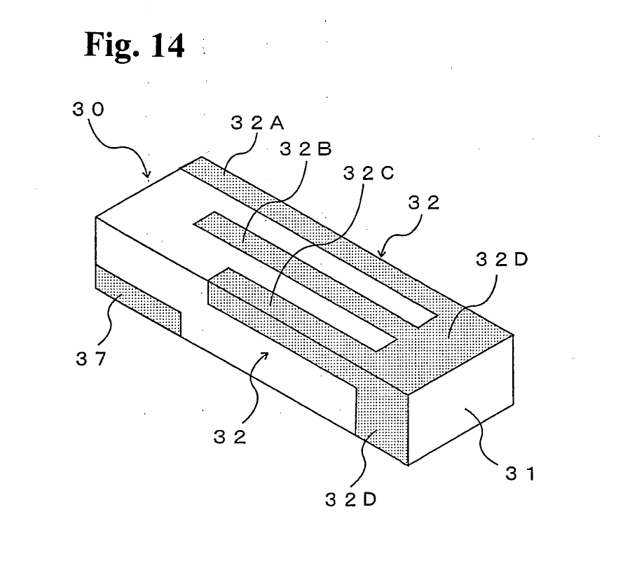

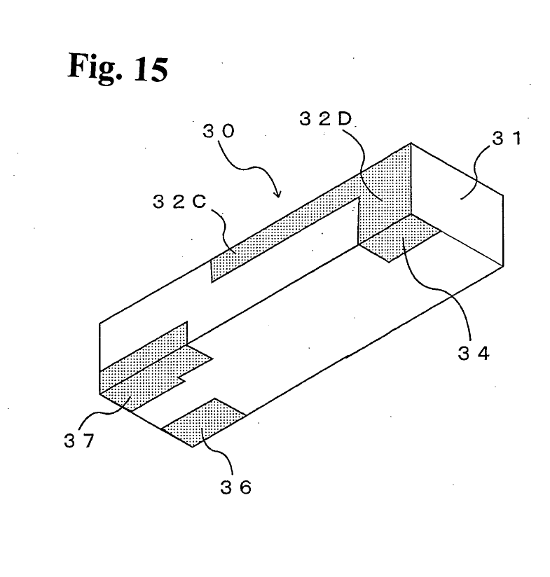

A chip antenna according to a third embodiment according of the present invention will be explained referring to FIGS. 14 and 15. A chip antenna 30 according to a third embodiment of the present invention is an antenna which is adapted to the ¼ wavelength having three resonant frequencies in an Ultra Wide Band (UWB) covering 3-11 GHz band.

The chip antenna 30 according to the third embodiment of the present invention comprises a base body 31 which is similar to the base body 11 in the chip antenna 10 according to the first embodiment of the present invention. The width of the base body 31 is set a little bit larger than the width of the base body 11 of the chip antenna 10. A first antenna element portion 32, a second antenna element portion 33, a first power supply portion 34, a second power supply portion 35, a land portion 36 and a ground portion 37 (which respectively correspond to the first antenna element portion 12, the second antenna element portion 13, the first power supply portion 14, the second power supply portion 15, the land portion 16 and the ground portion 17 in the chip antenna 10 according to the first embodiment) are formed on the surface of the based body 31.

The first antenna element portion 32 is adapted to three frequency bands of 2.5 GHz, 3.5 GHz and 5.8 GHz and is formed in a continuous pattern by belt shaped linear portions 32A, 32B and 32C and a wide belt shaped connecting portion 32D. The linear portion 32 A is longest among the three liner portions 32A, 32B and 32C and extends from one end to the other end in a longitudinal direction in the right side portion on the top surface of the base body 31.

The linear portion 32 B is second longest and extends from one end toward the other end to a predetermined length in parallel with the linear portion 32A in the center portion on the top surface of the base body 31. The linear portion 32C is shortest and extends from one end toward the other end to a predetermined length in parallel with the linear portion 32B in the left side portion on the top surface of the base body 31. The connecting portion 32D is formed across the top surface and the left side surface at one end of the base body 31 and connects the three linear portions 32A, 32B and 32C together.

The connecting portion 32D of the antenna element 32 continues to the power supply portion 34 which is formed in the left side portion on the bottom surface at one end of the base body 31.

In the antenna element portion 32, the longest linear portion 32A can transmit and receive radio waves in 2.5 GHz by cooperating with the connecting portion 32D. The second longest linear portion 32B can transmit and receive radio waves in 3.5 GHz by cooperating with the connecting portion 32D. The shortest linear portion 32C can transmit and receive radio waves in 5.8 GHz by cooperating with the connecting portion 32D.

The chip antenna 30 according to the third embodiment of the present invention functions as a monopole antenna in which the linear portion 32A can transmit and receive radio waves in 2.5 GHz band, the linear portion 32B can transmit and receive radio waves in 3.5 GHz band and the linear portion 32C can transmit and receive radio waves in 5.8 GHz band in cooperation with the connecting portion 32D respectively when the chip antenna 30 is attached to a bonding board (not shown) and power is supplied to the antenna element portion 32.

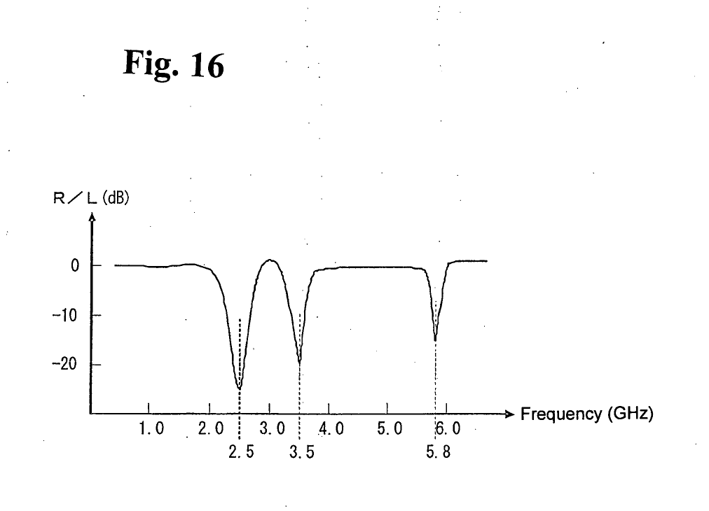

FIG. 16 shows a graphic relationship between a transmitting and receiving radio wave frequency and a return loss R/L in the chip antenna 30 according to the third embodiment of the present invention, and the return loss R/L is reduced to about −25 dB, −20 dB and −15 dB respectively in 2.5 GHz band, 3.5 GHz and 5.8 GHz.

A chip antenna according to the present invention is not limited to the aforementioned embodiments. For example, the dielectric constant ε of the dielectric plastic forming the base bodies 11, 21 and 31 of the chip antennas 10, 20 and 30 is set to an appropriate value in a range of between 4 and 20.
The size and shape of the base body (chip antenna) is not limited to those described above. The base body can have a very small size and can have a maximum length of about 10 mm and a minimum length of about 1 mm, preferably a maximum length of 8-5 mm and a minimum length of 3-1 mm, and can have a hexagonal cylindrical shape.

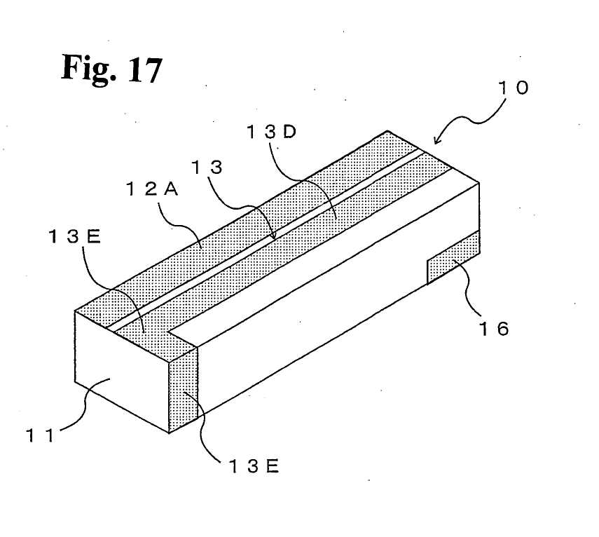

The second antenna element 13 shown in FIG. 2 can be alternatively formed in a continuous pattern of a belt shaped linear portion 13D and a belt shaped bended portion 13E as shown in FIG. 17. The linear portion 13S extends from one end of the chip antenna 10 to the other end. The bended portion 13E is formed across the top surface of the base body 11 and the right side surface of the base body 11 at one end.

In this case, the element length of the second antenna element portion 13 is longer than the element length of the first antenna element portion 12 by the length of the bended portion 13E and this chip antenna can transmit and receive radio waves in 3.5 GHz.

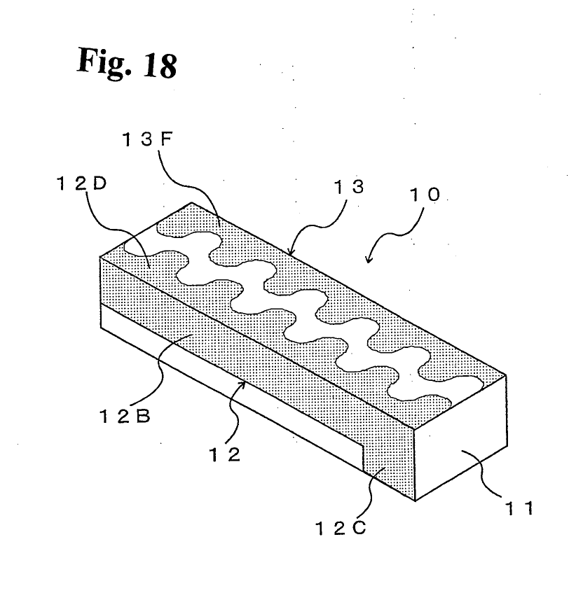

The first antenna element portion 12 and the second antenna element portion 13 shown in FIG. 1 can be formed in a pattern shown in FIG. 18. A wave shaped portion 12D as a first antenna element portion 12 and a wave shaped portion 13F as a second antenna element portion 13 are formed on the top surface of the base body 11. The wave shaped portion 12D extends from one end to the other end of the chip antenna 10. The wave shaped portion 13F extends from one end to the other end of the chip antenna 10.

In this case, the edge portion of the wave shaped portion 12D of the first antenna element portion 12 and the wave shaped portion 13F of the second antenna element portion 13 faces in parallel each other and therefore the first antenna element portion 12 and the second antenna element portion 13 are positioned in parallel.

1. A chip antenna which is adaptable to a plurality of frequency bands comprising a dielectric plastic base body and a plurality of antenna element portions having different element lengths, wherein the antenna element portions are formed in parallel each other on the base body.

2. A chip antenna according to claim 1, further comprising a plurality of power supply portions which are formed on the bottom surface of the base body and continues to the antenna elements, wherein the power supply portions are formed at positions where the power supply portions can be connected to a single power supply point on a mounting board by changing the position where the chip antenna is attached to the mounting board.

3. A chip antenna according to claim 1, wherein the antenna element portions and power supply portions are formed by patterning a conductive metal material layer which is plated on the dielectric plastic base body, and the dielectric constant of the dielectric plastic base body is set to a value in a range between 4 and 20.
